(19) United States
(12) Patent Application Publication
(10) Pub. No.: US 2011/0145226 A1
(43) Pub. Date: Jun. 16, 2011

(54) PRODUCT SIMILARITY MEASURE

(75) Inventors: Sreenivas Gollapudi, Cupertino, CA (US); Debmalya Panigrahi, Cambridge, MA (US)

(73) Assignee: Microsoft Corporation, Redmond, WA (US)

(21) Appl. No.: 12/634,748

(22) Filed: Dec. 10, 2009

(51) Int. Cl. G06F 17/30

(52) U.S. Cl. 707/723; 707/770; 707/E17.032; 707/E17.108

(57) ABSTRACT

Queries submitted by users looking for products and/or services are monitored and collected over a time period. Webpages corresponding to products and/or services bought by the users in response to submitting the queries are also monitored and collected over the time period. Attributes are extracted from the webpages and the queries, and the attributes are correlated to identify attributes that are similar to one another. The attributes are correlated to identify attributes that are not substitutable in a query. The identified attributes may be used to rank products and/or services that are responsive to a query based on attributes associated with the products and/or services, or to recommend alternative queries based on a submitted query by substituting one or more attributes of the query with similar attributes.

### BACKGROUND

When users are looking to purchase goods or services on the Internet, they typically transmit a query related to the goods or services to a search engine or merchant webpage. For example, a user looking for a purple Sony digital camera may submit the query “purple Sony digital camera” to a search engine or merchant webpage.

The search engine or merchant webpage may respond to the query by performing a keyword search using the terms of the query and may provide a list of the products that match. However, often no product will match all of the terms in the query. For example, there may be no purple Sony digital camera, but there may be a purple Sony television, a pink Nikon digital camera, and a purple Canon digital camera.

Typically in scenarios like the above scenario, the search engine or merchant website will present a subset of the resulting products, selected and ranked by the number of matching keywords. This approach is problematic because it assumes that all of the keywords are of equal importance and are equally substitutable. For example, the user may have only been interested in Sony digital cameras, but was flexible regarding the purple color. Thus, the user will reject the purple Canon camera, but would have been interested in seeing other Sony cameras regardless of the color.

### SUMMARY

Queries submitted by users looking for products or services are monitored and collected over a time period. In addition, webpages corresponding to products or services bought by the users in response to submitting the queries are also monitored and collected over the time period. Attributes are extracted from the webpages and the queries, and the attributes are correlated to identify attributes that are similar to one another. The attributes may be correlated to identify attributes that are not substitutable in a query. The identified attributes may be used to rank products and services that are responsive to a query based on attributes associated with the products and services, or to recommend alternative queries based on a submitted query by substituting one or more attributes of the query with similar attributes.

Queries may be received by a computer device through a network. Each query includes one or more attributes. Webpage identifiers may be received by the computer device through the network. Each webpage identifier is associated with one or more of the queries and each webpage identifier has one or more associated attributes. The attributes associated with a subset of the queries are correlated with the attributes associated with a subset of the webpage identifiers by the computer device. For each of a plurality of unique attribute pairs, a similarity score may be determined for the pair using the correlation.

Implementations may include some or all of the following features. An importance score of an attribute may be determined based on the correlation. The webpage identifiers may comprise uniform resource locators (URLs). The webpage identifiers may include browse trails. A query may be received. The query may include one or more attributes. One or more products (and/or services, for example) responsive to the query may be identified. Each product may have one or more attributes. A distance score may be determined for each product in a subset of the identified products, using the attributes associated with each product and the determined similarity scores. The products from the subset of identified products may be ranked using the distance scores. The products from the subset of identified products may be presented to a user in ranked order.

In some implementations, correlating the attributes associated with a subset of the plurality of queries with the attributes associated with a subset of the webpage identifiers may include, for each webpage identifier in the subset of the webpage identifiers, determining a frequency for each unique attribute pair for the webpage identifier. The subset of the webpage identifiers may be selected based on the frequency of each webpage identifier in the plurality of webpage identifiers. The subset of the attributes may be selected based on the frequency of each attribute associated with a webpage identifier. The webpage identifiers may include a graph, and the subset of the webpage identifiers may be selected using a heavy hitters algorithm.

A query may be received by a computer device through a network. The query includes one or more attributes. A plurality of products (and/or services) responsive to the query is identified by the computer device. Each product has one or more attributes. A distance score for each product from a subset of the identified products may be determined by the computer device. The similarity score is a measure of the distance between the one or more attributes of the query and the one or more of the attributes of a product. One or more of the identified products from the subset may be presented according to the distance score.

In an implementation, presenting one or more of the identified products from the subset according to the distance score may include presenting the identified products in rank order according to their distance scores.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment for determining attribute frequencies and recommending products based on user queries;

FIG. 2 shows a block diagram of an implementation of an example distance engine;

FIG. 3 is an operational flow of an implementation of a method for determining the similarity and importance of attributes by correlating attributes associated with queries and webpages;

FIG. 4 is an operational flow of an implementation of a method for recommending products using distance scores;

FIG. 5 is an operational flow of an implementation of a method for correlating query and webpage identifier data; and

FIG. 6 is a block diagram of a computing system environment according to an implementation of the present system.

### DETAILED DESCRIPTION

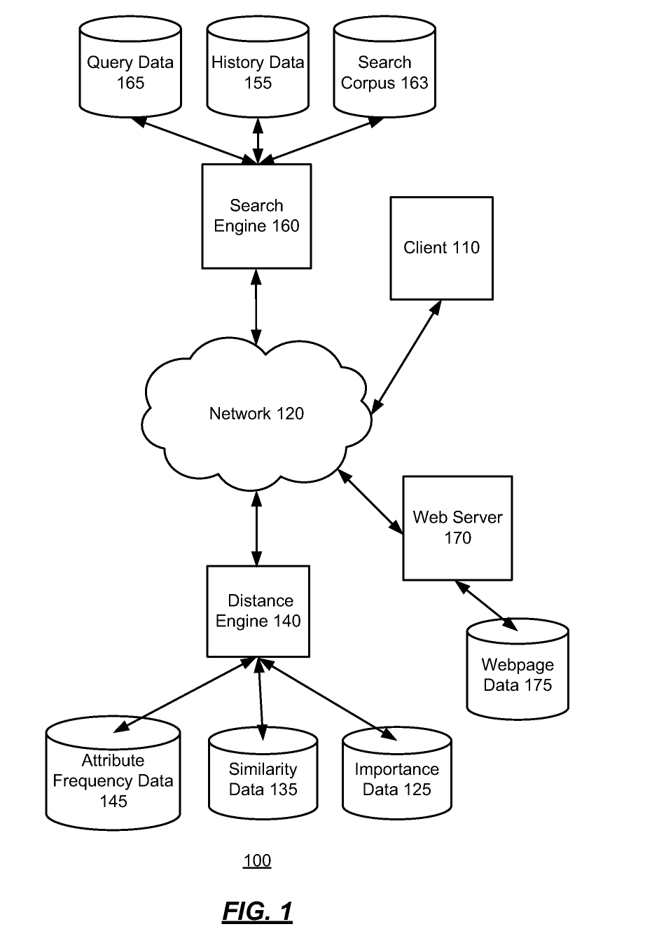

FIG. 1 is an illustration of an example environment 100 for determining attribute frequencies and recommending products based on user queries. A client 110 may communicate with a web server 170 (or more than one web server) and/or a search engine 160 (or more than one search engine) through a network 120. The client 110 may be configured to communicate with the web server 170 and search engine 160 to access, receive, retrieve and display media content and other information such as webpages. The network 120 may be a variety of network types including the public switched telephone network (PSTN), a cellular telephone network, and a packet switched network (e.g., the Internet).

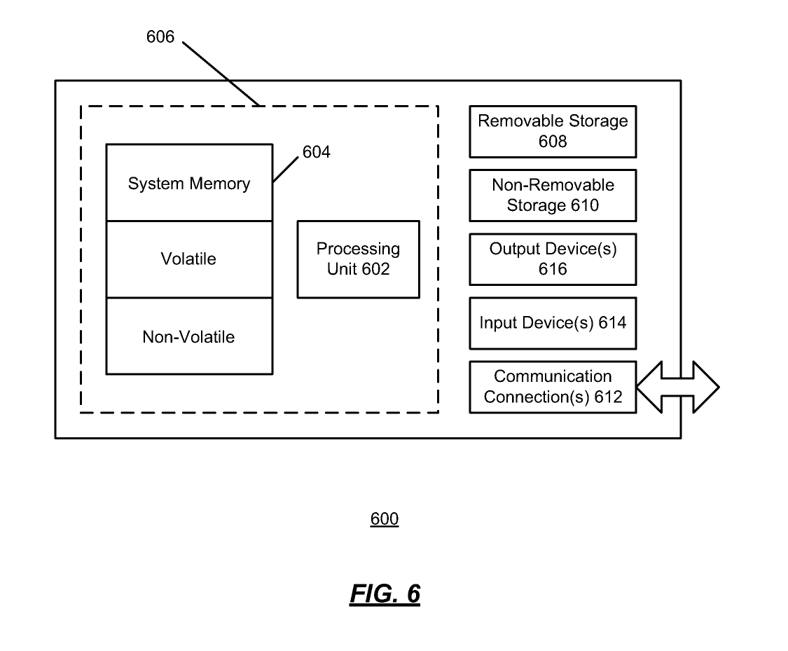

In some implementations, the client 110 may include a desktop personal computer, workstation, laptop, personal digital assistant (PDA), cell phone, or any wireless application protocol (WAP) enabled device or any other computing device capable of interfacing directly or indirectly with the network 120. The client 110 may run a hypertext transfer protocol (HTTP) client, e.g., a browsing program, such as MICROSOFT INTERNET EXPLORER or other browser, or a WAP enabled browser in the case of a cell phone, PDA or other wireless device, or the like, allowing a user of the client 110 to access, process, and view information and pages available to it from the search engine 160. The client 110 may be implemented using a general purpose computing device (also referred to herein as a computer device) such as the computing device 600 illustrated in FIG. 6, for example.

The web server 170 may be configured to provide webpages responsive to requests received from users using devices such as the client 110. The webpages may be stored as webpage data 175, for example. The web server 170 may also allows users to search for and view webpages associated with various products and services. For example, the web server 170 may be associated with an electronics retailer and users may browse and search for electronics available for sale by providing queries to the web server 170. The web server 170 may then return a set of webpage identifiers of webpages stored in the webpage data 175. The particular set of webpages stored by the web server 170 may be referred to as the domain of the web server 170, for example.

The search engine 160 may be configured to receive queries from users using clients such as the client 110. The search engine 160 may search for media responsive to the query by searching a search corpus 163 using the received query. The search corpus 163 may be an index of media such as webpages (e.g., webpages from the webpage data 175), product descriptions, image data, video data, map data, etc. The search engine 160 may return a webpage to the client 110 including links to some or all of the media that is responsive to the query.

In some implementations, the search engine 160 may store some or all of the queries that it receives as query data 165. Each query may include several terms. For example, the query “Sony Television” may include the term “Sony” and the term “television”. In some implementations, the queries may further be characterized by genre or type. For example, the above described query may be of the genre “electronics”, or even more specifically “television”. The genres may be automatically determined or may be manually determined. Further, while not illustrated, a web server 170 may also collect and store query data 165 based on queries received by the web server 170, for example.

In some implementations, each query stored in the query data 165 may have associated attributes. In some implementations, the attributes may correspond to the terms of the queries. Thus, the query “Sony Television” may be associated with the attributes “Sony” and “Television”. In other implementations, the attributes may be based on the terms but may not exactly correspond to the terms of the query. This may be because of spelling corrections, the removal of redundant or unimportant terms, or for attribute standardization. For example, the query “Sony TV” may be associated with the attributes “Sony” and “Television”, rather than “Sony” and “TV”. The attributes may be generated by the search engine 160 or alternatively may be user generated.

In some implementations, the search engine 160 may further store history data 155. The history data 155 may include descriptions of the online behavior of users during a search session after submitting a query from the query data 165. For example, in one implementation, the history data 155 may include identifiers (e.g., uniform resource locators (URLs)) of the various webpages that a user visited during a search session. These types of browsing histories are known as browse trails. Where the history data 155 comprises browse trails, the history data 155 may be represented by a graph with nodes representing each webpage visited during a search session and edges representing links that have been followed, for example. Other types of history data 155 may also be stored. For example, in some implementations, only the final webpage in a search session is stored. Further, while not illustrated, a web server 170 may also collect and store history data 155 based on search sessions taking place at the web server 170, for example.

In some implementations, similarly as described above for the query data 165, the history data 155 may be classified by genre or category. Thus, search sessions that ended in webpages associated with electronics may be categorized as electronics related. In addition, the history data 155 may be associated with a particular domain. For example, a search session that takes place at the web server 170 may be associated with an attribute that identifies the domain of the web server 170.

In some implementations, the history data 155 may be further associated with one or more attributes. Where the history data 155 comprises webpage identifiers (e.g., URLs), the attributes may be based on words extracted from the text or title of the identified webpages, for example. In some implementations, the attributes may be extracted by a module or application that is trained to extract relevant attributes from a webpage. In other implementations, the attributes may be manually determined. For example, from a webpage associated with a particular product, attributes such as the model name, product type, product color, and brand name may be extracted. Other types of attributes may also be extracted.

The environment 100 may further include a distance engine 140. The distance engine 140 may calculate a distance score based on the distance or difference between two items such as products, services, webpages, etc., based on the attributes associated with the items. The calculated distance score may be used by the search engine 160 or the web server 170 to select one or more products, services, webpages, etc., to present (e.g., provide, display, recommend, and the like) to a user based on attributes associated with a query submitted by the user. The distance engine 140 may be implemented using a general purpose computing device (also referred to herein as a computer device) such as the computing device 600 illustrated in FIG. 6, for example.

In some implementations, the distance engine 140 may receive the query data 165 and the history data 155 from the search engine 160. Alternatively or additionally, the query data 165 and the history data 155 may be received from one or more web servers. In some implementations, both the query data 165 and the history data 155 may be received in their entirety. In other implementations, the data may be streamed to the distance engine 140. For example, where the history data 155 is implemented as a large graph, streaming may be used.

In some implementations, the distance engine 140 may correlate the attributes associated with the queries from the query data 165 with the attributes associated with a subset of the webpages identified using the history data 155. In some implementations, the distance engine may 140 may correlate query data 165 and history data 155 associated with a particular category or genre of queries. The distance engine 140 may use the correlations to generate attribute frequency data 145. In some implementations, the attribute frequency data 145 describes, for each webpage identified by the history data 155 and each attribute j associated with the webpage, the frequency with which a query having an attribute i reached the webpage. This frequency may be referred to as pᵢⱼ. Because of the large number of attributes and webpages identified by the history data 155, in some implementations, the value of pᵢⱼ may be estimated rather than calculated exactly. Moreover, pᵢⱼ may only be calculated for the top k identified webpages by frequency as well as for the top k attributes, for example. In some implementations, the attribute frequency data 145 may comprise a vector of attribute frequencies pᵢⱼ for all (or some subset of) the webpages identified in the history data 155, for example.

In some implementations, the distance engine 140 may use the attribute frequency data 145 to determine the similarities of attribute pairs, as well as a relative importance of an attribute. A determined similarity score of an attribute pair and an importance score of an attribute may then be applied to attributes of a query. The similarity score of an attribute pair ij may represent the degree of similarity between the two attributes. In some implementations, the similarity score is a numerical score with a higher score indicating a high level of similarity and a lower score indicating a low level of similarity. However, other scoring methods or systems may also be used for the similarity score. Two attributes with a high similarity score (e.g., a score above a predetermined threshold) may be substituted for each other in a query. Similarly, attributes with a low level of similarity (e.g., a score below a predetermined threshold) may not be substituted with each other. The determined similarities of attribute pairs may be stored as the similarity data 135, for example.

The importance score of an attribute measures the relative importance of an attribute among the other attributes. Similarly to the similarity score, the importance score may be a numerical score where a higher importance score evidences high importance and a lower importance score evidences low importance. An attribute with a high importance score (e.g., as compared with a threshold, e.g., determined by a user or an administrator) may not be substituted with another attribute or removed from the attributes of a query. The determined importance score may be stored as the importance data 125.

For example, in the query “Sony pink digital camera”, the attribute “pink” may have a low importance score and a high similarity score with the attribute “purple”. This may indicate that the attribute “pink” may be removed from the query or substituted with “purple”. The attribute “Sony” may have a high importance score and a low similarity score with the attribute “Nikon”. This indicates that the attribute “Sony” cannot be removed from the query or substituted with the attribute “Nikon”.

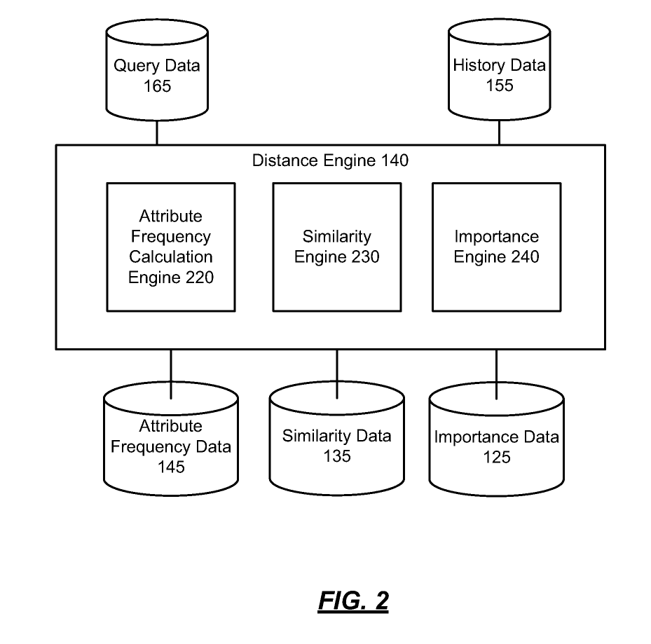

Thus, as will be described further with respect to FIG. 2, the distance engine 140 may further generate a product distance score which is a measure of the distance between two products based on the attributes associated with the products and the similarity data 135. The distance engine 140 may further recommend or generate similar queries from a received query using the terms of the queries as attributes and the similarity data 135 and the importance data 125.

FIG. 2 shows a block diagram of an implementation of an example distance engine 140. As illustrated, the distance engine 140 may include an attribute frequency calculation engine 220, a similarity engine 230, and an importance engine 240.

In some implementations, the attribute frequency calculation engine 220 may correlate attributes associated with the queries from the query data 165 with the attributes associated with a subset of the webpages identified by the history data 155. The generated correlations may be stored as the attribute frequency data 145, for example.

As described above, because the number of webpages identified by the history data 155 (e.g., URLs) may be large, the attribute frequency calculation engine 220 may only use a subset of the identified webpages to calculate the attribute frequency data 145. The webpage identifiers selected may correspond to the most popular webpages in the history data 155, or webpages that are most frequently associated with queries from the query data 165. In some implementations, the attribute frequency calculation engine 220 may choose the top k most frequent webpage identifiers from the history data 155. The particular value of k may be chosen by a user or administrator based on the amount of computational resources available and/or the accuracy wanted, for example.

In some implementations, where the history data 155 is received as a stream, the top k webpage identifiers may be chosen using a streaming algorithm such as a heavy hitters algorithm. An example heavy hitters algorithm is described by Karp et al. in “A Simple Algorithm for Finding Frequent Elements in Streams and Bags”, ACM Transactions on Database Systems, 2003. However, any heavy hitters algorithm or streaming algorithm or technique may be used.

The attribute frequency calculation engine 220 may select attributes associated with the selected webpage identifiers to perform the correlation. In some implementations, the attribute frequency calculation engine 220 may select all of the attributes associated with the history data 155. In some implementations, the attribute frequency calculation may only select a subset of the attributes. For example, the attribute frequency calculation may use the top k most frequent attributes similarly as done for the webpage identifiers. The attributes may be the most frequent attributes among the webpage identifiers, or alternatively may be the most frequent among the queries associated with the webpage identifiers. The top k most frequent attributes may also be selected using a heavy hitters algorithm or any streaming algorithm; however, any method or technique may be used.

The attribute frequency calculation engine 220 may calculate attribute pair frequencies for each of the webpage identifiers in the history data 155, or as described above, a subset of the webpage identifiers in the history data 155. An attribute pair frequency pᵢⱼ for a webpage identifier may describe the frequency with which a query having an attribute i is associated with the webpage identifier having the attribute j. In some implementations, an attribute pair frequency may be determined for the attributes associated with each webpage identifier. The set of attribute frequency pairs generated for a webpage identifier may be represented as a vector v. In some implementations, the frequencies may be normalized to a particular range. The vector v for each webpage identifier may be stored as part of the attribute frequency data 145, for example.

The attribute frequency calculation engine 220 may further calculate the frequencies of attribute pairs. The attribute frequency calculation engine 220 may generate, for each attribute, a frequency vector u that represents the frequency of that attribute across the identified webpages. Thus, uⱼ may represent the frequency of the attribute j across the webpages in the history data 155. The set of vectors u may be similarly stored in the attribute frequency data 145, for example.

The similarity engine 230 may determine similarity scores for attribute pairs ij using the attribute frequency data 145. In some implementations, the similarity score for an attribute pair ij may be determined by taking the inner product of the vectors vᵢ and uⱼ, for example. The similarity scores for attribute pairs may be pre-computed for the top k attributes, or all attributes, and accessed by the similarity engine 230 or the distance engine 140 at run time (e.g., when a query is received).

The importance engine 240 may determine importance scores for attributes using the attribute frequency data 145. One measure of the importance of an attribute is the likelihood that it will be substituted with another attribute. An attribute having a high importance will have a low calculated similarity score with other attributes other than itself. Thus, an attribute i may be important if there is no attribute j where the calculated similarity of ij is greater than the calculated similarity of ii (i.e., its similarity with itself). An importance score for each of the top k attributes, or all attributes, may be calculated based on the similarity scores for the attribute with respect to the other attributes. The calculated importance scores may be stored as the importance data 125, for example.

The distance engine 140 may generate product distance scores for one or more identified products for a query using the similarity scores and importance score calculated for the attributes associated with one or more products. In some implementations, the distance engine 140 may determine the product distance score for a product by computing the sum of the similarity scores for each attribute i of the query with respect to each attribute j of the product. Similarly, the distance engine 140 may compute the similarity of two products by computing the sum of the similarity scores for each attribute i of the first product with each attribute j of the second product. In some implementations, the computed similarity score may be normalized. The distance engine 140 may then rank or present the one or more products to the user according to the generated product distance scores.

For example, a query for “Blue Nikon 10 megapixel” may result in a match of three products. The three products may include a blue Sony 12 megapixel camera, a blue Nikon 8 megapixel camera, and a green Nikon 10 megapixel camera. The distance engine 140 may use the attributes from the query and the identified products to compute a product distance score for each product with respect to the query. The distance engine 140 may determine that the blue Nikon 8 megapixel camera is the best match, followed by the green Nikon 10 megapixel camera and the blue Sony 12 megapixel camera.

In some implementations, the distance engine 140 may substitute one or more attributes of a query with one or more alternate attributes based on the similarity and importance data. The distance engine 140 may use the similarity scores to select an attribute having the highest similarity score with an attribute of the query as indicated by the similarity data 135 and substitute the attribute of the query with the selected attribute. Moreover, the distance engine 140 may use the importance data 125 to recognize attributes that have high importance scores and therefore should not be substituted.

Continuing the example described above, a query may be received by the distance engine for “Blue Nikon 10 megapixel”. The distance engine 140 may use the similarity data to determine that the attribute “purple” is highly similar to “blue” and that “blue” may therefore be substituted with “purple” in the query. The distance engine 140 may further determine that the attribute “Nikon” may have a high importance score and is therefore not substitutable in the query.

In some implementations, the distance engine 140 may assume that there is no dependence between the attributes, i.e., the similarity between values of one attribute is independent of similarity between values of other attributes. For example, assume a product q=(q₁, q₂, . . . , qₖ) and a product q′=(q′₁, q′₂, . . . , q′ₖ) where qᵢ and q′ᵢ are values of the same attributes. In such case, the distance engine 140 may calculate the distance using the function d_{qq′}=(Σᵢ₌₁^{k}d_{qiq′i}^{p})^{1/p} for some p>0. This distance function is the Lₚ-norm of the vector between q and q′.

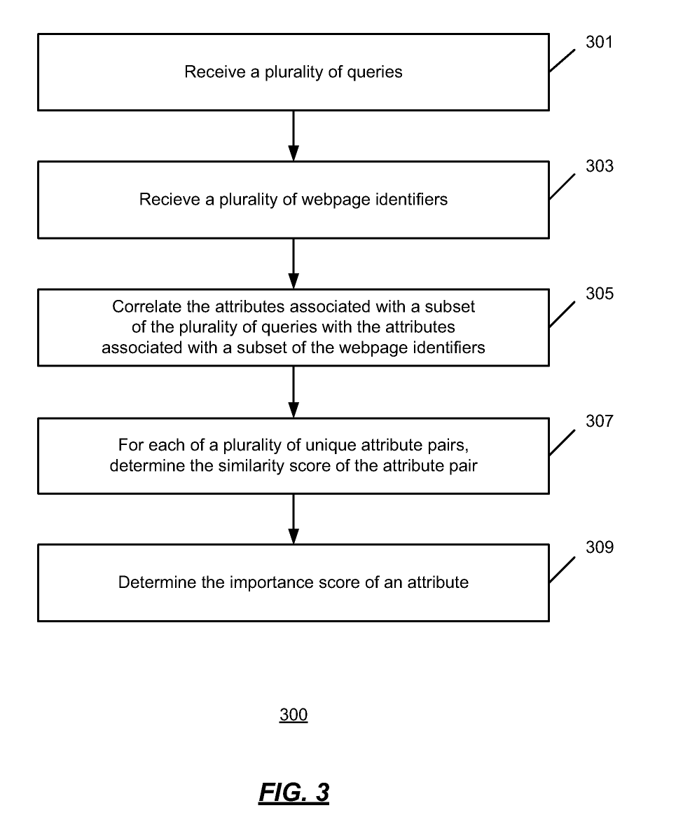

FIG. 3 is operational flow of an implementation of a method 300 for determining similarity and importance scores for attributes by correlating attributes associated with queries and webpages. The process 300 may be implemented by the distance engine 140, for example.

A plurality of queries is received (301). In some implementations, the plurality of queries may be received by the distance engine 140. The received queries may be part of the query data 165 and may include one or more attributes associated with each query. The query data 165 may be collected over time by the search engine 160 and may be associated with a particular genre or domain. For example, the query data 165 may comprise queries that are associated with electronic products, or may be queries that led users to a merchant's or company's domain name, for example.

A plurality of webpage identifiers is received (303). The plurality of webpage identifiers may be comprised within the history data 155 and may be received by the distance engine 140 from the search engine 160, for example. The webpage identifiers may be URLs, for example. In some implementations, the webpage identifiers may comprise, may be based on, or may be part of browse trails associated with one or more of the queries from the query data 165. The history data 155 may be received (e.g., in its entirety) by the distance engine 140, or may be streamed as a graph stream to the distance engine 140, for example.

Each webpage identifier may be further associated with one or more attributes. In some implementations, the attributes associated with each webpage identifier are limited to the most frequent attributes associated with the webpage identifier. In some implementations, the webpage identifier may be associated with a particular domain and the attributes associated with the webpage identifier may be the most frequent attributes associated with the domain in one or more browse trails, for example.

The attributes associated with a subset of the queries are correlated with the attributes associated with a subset of the webpage identifiers (305). The attributes may be correlated by the attribute frequency calculation engine 220 of the distance engine 140, for example. In some implementation, the attribute frequency calculation engine 220 may determine, for each webpage identifier from the history data 155, a frequency value associated with each unique attribute pair ij, where the attribute i is associated with a query associated with the webpage identifier and the attribute j is associated with the webpage identifier. The frequency may represent the frequency with which a query having the attribute i led a user to a webpage having the attribute j.

Alternatively or additionally, the frequency may represent the frequency with which a query having the attribute i had a webpage having the attribute j in a browse trail associated with the search session initiated by the query. In some implementations, the frequency may be further adjusted based on the amount of time the user spent on each webpage that is part of a browse trail or based on the overall length of a browse trail. For example, attributes associated with long browse trails may indicate dissatisfied users and attributes associated with such webpages may be discounted. Similarly, webpages having long browse times may indicate a satisfied user and their associated attributes may be weighted more heavily than other attributes or given a higher frequency.

For each of the unique attribute pairs, a similarity score for the pair may be determined (307). The similarity score may be determined by the similarity engine 230, for example. In some implementations, the similarity score for an attribute pair describes the similarity of the two attributes. The similarity score may be used to determine the substitutability of an attribute for another attribute. For example, an attribute with a low similarity score with respect to another attribute may not be substitutable with each other, whereas attributes with a high similarity score may essentially be synonyms for one another.

In some implementations, the similarity scores for two attribute pairs may be determined by the similarity engine 230 by calculating the product of the determined frequency values for the two attributes across the webpage identifiers. Other methods for determining the similarity scores may also be used.

An importance score may be determined for one or more attributes (309). The importance scores may be generated by the importance engine 240 of the distance engine 140, for example. The importance score may be a measure of how important a particular attribute is when part of a query. The importance score for an attribute may be determined from the determined frequency values for the attribute pairs by the importance engine 240.

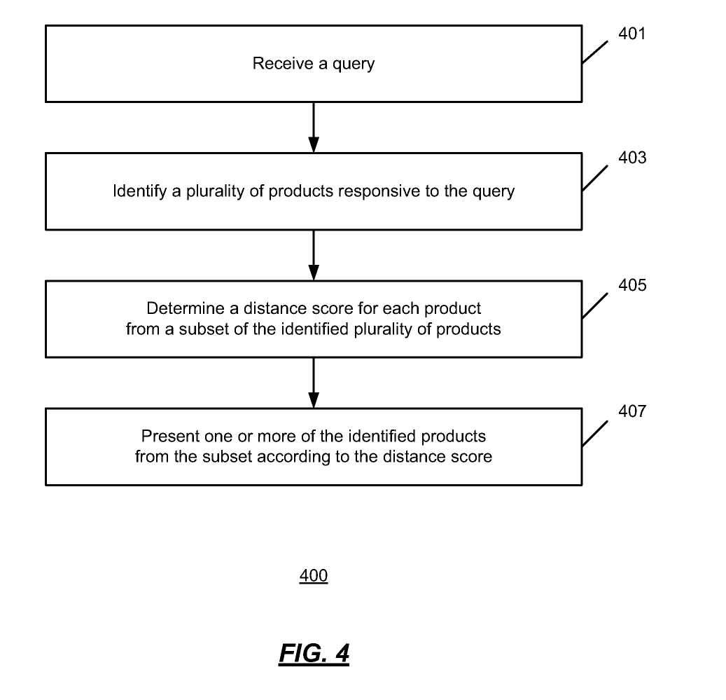

FIG. 4 is an operational flow of an implementation of a method 400 for recommending products using distance scores. The process 400 may be implemented using the distance engine 140, the search engine 160, or the web server 170, for example.

A query is received (401). The query may be received by the search engine 160, for example. The query may include one or more attributes. For example, the query “black dress” includes the attributes “black” and “dress”. The query may be received from a client 110.

A plurality of products that are responsive to the query is identified (403). The products may be identified by the search engine 160, for example. The products responsive to the query may be identified using a variety of techniques including keyword searches.

Each identified product may have one or more associated attributes. The attributes may correspond to traits or characteristics of the products. For example, a purple dress may have the attributes “purple” and “dress” associated with it. The attributes for each product may be associated with the product through a webpage associated with the product or the attributes may be associated with a product through structured data, for example.

A distance score for each of the products from a subset of the identified products is determined (405). The distance score may be calculated by the distance engine 140 and/or the search engine 160, for example. The distance score may indicate the overall similarity of a product to the received query. The distance score may be determined for a product by comparing the terms or attributes of the query with the attributes associated with each product. In an implementation, the distance engine 140 may calculate the distance score using the similarity data 135 and/or the importance data 125.

One or more of the identified products may be presented according to the distance scores (407). The products may be presented to a user at the client 110 by the search engine 160, for example. In some implementations, the products may be presented in a webpage that is sent to the client 110. The products may also be ranked according to their distance scores and presented in ranked order.

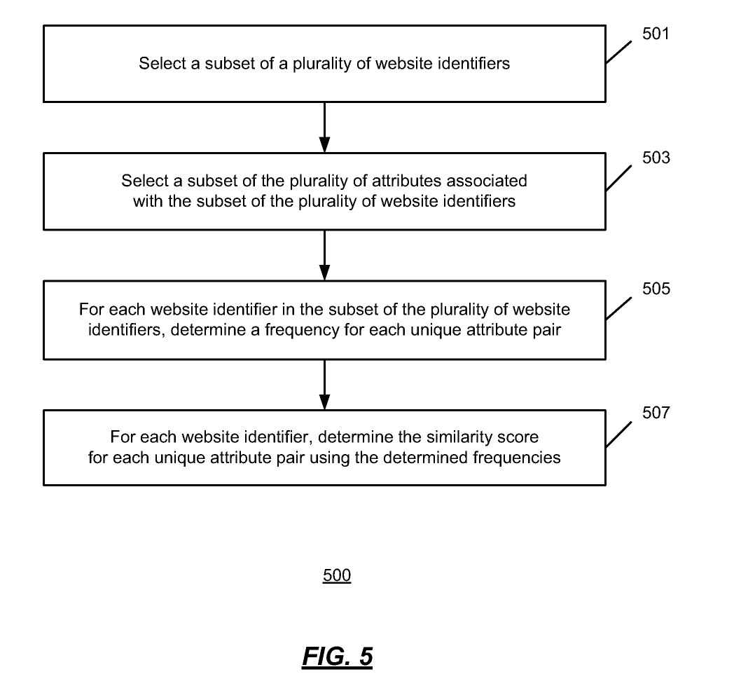

FIG. 5 is an operational flow of an implementation of a method 500 for correlating query and webpage identifier data. The process 500 may be performed by the distance engine 140, for example.

A subset of a plurality of webpage identifiers is selected (501). The subset of the plurality of webpage identifiers may be selected by the attribute frequency calculation engine 220, for example. In some implementations, the subset of the plurality of webpage identifiers may correspond to the top k webpages identified by the history data 155. The subset may be selected by the attribute frequency calculation engine 220 using a heavy hitters algorithm. However, other streaming algorithms and techniques may also be used.

A subset of the attributes associated with the subset of the plurality of webpage identifiers is selected (503). The subset may be selected by the attribute frequency calculation engine 220, for example. Similarly to the webpage identifiers discussed above, the subset of attributes may correspond to the top k attributes associated with the identified webpages. The top k attributes may also be selected using a heavy hitters algorithm, but other algorithms and techniques may also be used.

For each webpage identifier in the subset of the plurality of webpage identifiers, a frequency for each unique attribute pair may be determined (505). The frequency may be determined by the attribute frequency calculation engine 220, for example. The determined frequency for each pair may be stored as the attribute frequency data 145.

A similarity score for each unique attribute pair may be determined using the determined frequencies (507). The similarity scores may be determined by the similarity engine 230 using the attribute frequency data 145. The generated similarity scores may be stored as the similarity data 135 and used later by the distance engine 140 to generate a product distance score.

FIG. 6 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a plurality of queries by a computer device through a network, wherein each query comprises one or more attributes;
receiving a plurality of webpage identifiers by the computer device through the network, wherein each webpage identifier is associated with one or more of the plurality of queries and each webpage identifier has one or more associated attributes;
correlating the attributes associated with a subset of the plurality of queries with the attributes associated with a subset of the webpage identifiers by the computer device; and
for each of a plurality of unique attribute pairs, determining a similarity score for the pair using the correlation by the computer device.

2. The method of claim 1, further comprising determining an importance score for an attribute based on the correlation.

3. The method of claim 1, wherein the webpage identifiers comprise uniform resource locators (URLs).

4. The method of claim 1, wherein the plurality of webpage identifiers comprise browse trails.

5. The method of claim 1, further comprising:
receiving a query, wherein the query comprises one or more attributes;
identifying one or more products responsive to the query, wherein each product has one or more attributes; and
determining a distance score for each product in a subset of the identified one or more products using the attributes associated with each product, the attributes of the query, and the determined similarity scores.

6. The method of claim 5, further comprising ranking the products from the subset of identified products using the distance scores.

7. The method of claim 5, further comprising presenting the products from the subset of identified products to a computing device of a user in a ranked order.

8. The method of claim 1, wherein correlating the attributes comprises, for each webpage identifier in the subset of the webpage identifiers, determining a frequency for each unique attribute pair for the webpage identifier.

9. The method of claim 8, further comprising selecting the subset of the webpage identifiers from the plurality of webpage identifiers based on the frequency of each webpage identifier in the plurality of webpage identifiers.

10. The method of claim 9, wherein the webpage identifiers comprise a graph, and the subset of the webpage identifiers is selected using a heavy hitters algorithm.

11. A method comprising:
receiving a query by a computer device through a network, the query comprising one or more attributes;
identifying a plurality of products responsive to the query by the computer device, wherein each product has one or more attributes;
determining a distance score for each product from a subset of the identified plurality of products by the computer device, wherein the similarity score is a measure of the distance between the one or more attributes of the query and the one or more attributes of the product; and
presenting one or more of the identified products from the subset according to the distance score by the computer device through the network.

12. The method of claim 11, wherein presenting one or more of the identified products comprises presenting the one of more identified products in a rank order according to their distance score.

13. A system comprising:
at least one computing device that:
stores a plurality of queries, wherein each query comprises one or more attributes; and
stores a plurality of webpage identifiers, wherein each webpage identifier is associated with one or more of the plurality of queries and each webpage identifier has one or more associated attributes; and
a distance engine that:
correlates the attributes associated with a subset of the plurality of queries with the attributes associated with a subset of the webpage identifiers; and
for each of a plurality of unique attribute pairs, determines a similarity score for the pair using the correlation.

14. The system of claim 13, wherein the distance engine further determines an importance score of an attribute based on the correlation.

15. The system of claim 13, wherein the webpage identifiers comprise uniform resource locators (URLs).

16. The system of claim 13, wherein the plurality of webpage identifiers comprise browse trails.

17. The system of claim 13, wherein the distance engine further:
receives a query, wherein the query comprises one or more attributes;
identifies one or more products responsive to the query, wherein each product has one or more attributes; and
determines a distance score for each product using the attributes associated with each product, the attributes of the query, and the determined similarity scores.

18. The system of claim 13, wherein the distance engine correlates the attributes by, for each webpage identifier in the subset of the webpage identifiers, determining a frequency for each unique attribute pair for the webpage identifier.

19. The system of claim 18, wherein the distance engine further selects the subset of the webpage identifiers from the plurality of webpage identifiers based on the frequency of each webpage identifier in the plurality of webpage identifiers.

20. The system of claim 19, wherein the webpage identifiers comprise a graph, and the subset of the webpage identifiers is selected by the distance engine using a heavy hitters algorithm.
